(19) United States
(12) Patent Application Publication
(10) Pub. No.: US 2025/0074285 A1
(43) Pub. Date: Mar. 6, 2025

(54) GROUND-LOADING VEHICLE PLATFORM FOR PICKUP TRUCK

(71) Applicant: 3DESCO DESIGN INC., Saint-Mathieu-de-Beloeil (CA)

(72) Inventors: François GARNEAU, Beloeil (CA); Pascal LAURENDEAU, Verdun (CA)

(21) Appl. No.: 18/953,310

(22) Filed: Nov. 20, 2024

Related U.S. Application Data
(63) Continuation of application No. 17/348,201, filed on Jun. 15, 2021, now Pat. No. 12,168,406.
Application No. 17/348,201 is a continuation of application No. 15/644,746, filed on Jul. 8, 2017, now Pat. No. 11,059,410.

(51) Int. Cl. B60P 1/44; B60P 1/48; B60P 3/06

(52) U.S. Cl. CPC B60P 1/4407; B60P 1/4471; B60P 1/48; B60P 3/06

(57) ABSTRACT

A hydraulic deck comprising a frame consisting of a pair of horizontal members and a pair of vertical members, wherein the frame is configured to be mounted in a bed of a pickup truck; a pair of pivot arm members in telescoping engagement with the pair of horizontal members and a pair of extension members in telescoping engagement with the pair of vertical members; a platform member configured to support at least one vehicle; a pair of pillars rotationally connected to pin members positioned on the pair of extension members, wherein the pair of pillar extend perpendicularly from the platform member; and a mechanically operating lifting system configured to slide and lower the platform from the bed in a stored position to a ground surface in a loading position.

### CROSS-REFERENCE TO RELATED APPLICATIONS

The present application is a continuation application of U.S. patent application Ser. No. 17/348,201 filed on Jun. 15, 2021, now allowed, which, in turn, is a continuation application of U.S. patent application Ser. No. 15/644,746 filed on Jul. 8, 2017, now U.S. Pat. No. 11,059,410 issued Jul. 13, 2021, which, in turn, claims priority to United Kingdom Patent Application serial number 1611973.7, filed on Jul. 9, 2016 entitled “Hydraulic Deck for Sled and All Terrain Vehicle (ATV)”, the contents of which are hereby incorporated by reference in their entirely.

### BACKGROUND OF THE INVENTION

### 1. Field of the Invention

The present invention generally relates to racks, attachment structures and platforms but more particularly to a hydraulic deck for mounting vehicles on a pickup truck.

### 2. Description of Related Art

There are limited options when transported recreational vehicles, such as snowmobiles, ATV, and motorcycles. One option is by way of a hitched trailer. Another option is by mounting and securing them inside a bed of a pickup truck. In both cases, a ramp is required for loading and unloading the recreational vehicle. In the art, there are tiltable trailers that exist, which do not require a ramp, as the tilting of the trailer brings its tail down to the ground. In all cases, however, there is an incline that has to be negotiated and it can be challenging if the recreational vehicle is heavy. Consequently, there needs to be an improved for mounting recreational vehicles on a pickup truck.

### BRIEF SUMMARY OF THE INVENTION

In one embodiment of the present invention, hydraulic deck is provided, comprising a frame consisting of a pair of horizontal members and a pair of vertical members, wherein the frame is configured to be mounted in a bed of a pickup truck; a pair of pivot arm members in telescoping engagement with the pair of horizontal members and a pair of extension members in telescoping engagement with the pair of vertical members; a platform member configured to support at least one vehicle; a pair of pillars rotationally connected to pin members positioned on the pair of extension members, wherein the pair of pillar extend perpendicularly from the platform member; and a mechanically operating lifting system configured to slide and lower the platform from the bed in a stored position to a ground surface in a loading position.

In one embodiment, the mechanically operating lifting system includes a pair of weldments forming a structural body configured and sized to fit inside the bed of the pickup truck. In one embodiment, the mechanically operating lifting system comprises a pair of chain loops and a pair of piston members, wherein each of the pair of chain loops are configured to engage a first and second pair of sprockets respectively, and the pair of piston members each having a piston rod connected to each of the pair of chain loops via connection brackets. In one embodiment, the pair of chain loops, the pair of piston members, the first and second pair of sprockets, and connection brackets are designed to fit inside the pair of weldments. In one embodiment, each of the first and second pair of sprockets of are located at opposite ends of each of the pair of chain loops respectively.

In one embodiment, a pair of sprocket adjustment members configured to adjust the distance between the each of the first and second pairs of sprockets to regulate the tension of each of the pair of chain loops are provided. In another embodiment, a plurality of turnbuckles configured to attach the structural body to the bed of the pickup truck are provided. In one embodiment, the structural body includes a pair of extension elements configured to support and guide the platform member during operation, wherein each of the pair of extension elements include a caster wheel at each respective distal end of the pair of extension elements. In another embodiment, each of the pair of extension elements are constructed with a hockey stick shape. In yet another embodiment, a sub platform underneath the platform member is provided. In one embodiment, the sub platform includes a pair of support ledges configured to provide support to the at least one vehicle.

In one embodiment, the at least one vehicle is a vehicle having a sled. In another embodiment, the at least one vehicle is selected from the list of an all-terrain vehicle, an off-highway vehicle, a utility vehicle, a motorcycle, or a sled vehicle. In one embodiment, extension support members configured to accept two vehicles side by side are provided. In yet another embodiment, a pair of skates extending from a pair of protracting members are provided, wherein the pair of skates is configured to make first contact with the ground surface when the platform is lowered. In one embodiment, each of the pair of skates includes a wheel facilitating the operation of the platform member after first contact with the ground surface.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a hydraulic deck according to an embodiment of the present invention.

FIG. 2 is an exploded view of the hydraulic deck according to an embodiment of the present invention.

FIGS. 3A-B are isometric views of the sub platform of the hydraulic deck according to an embodiment of the present invention.

FIGS. 4A-B are isometric views of the platform with the sub platform of the hydraulic deck retracted and protracted respectfully according to an embodiment of the present invention.

FIG. 5 is a detailed view of a skate of the hydraulic deck according to an embodiment of the present invention.

FIG. 6 is a perspective view of the hydraulic deck mounted on a pickup truck according to an embodiment of the present invention.

FIG. 7 is a section view of the hydraulic deck mounted on the pickup truck according to an embodiment of the present invention.

FIG. 8 is a perspective view of a vehicle installed on the platform of the hydraulic deck mounted on the pickup truck according to an embodiment of the present invention.

FIGS. 9A-E are section views of the operation of the hydraulic deck according to an embodiment of the present invention.

FIGS. 10A-B are exploded views of the top side and the bottom side of the platform and the sub platform with extensions according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide hydraulic deck for mounting vehicles on a pickup truck.

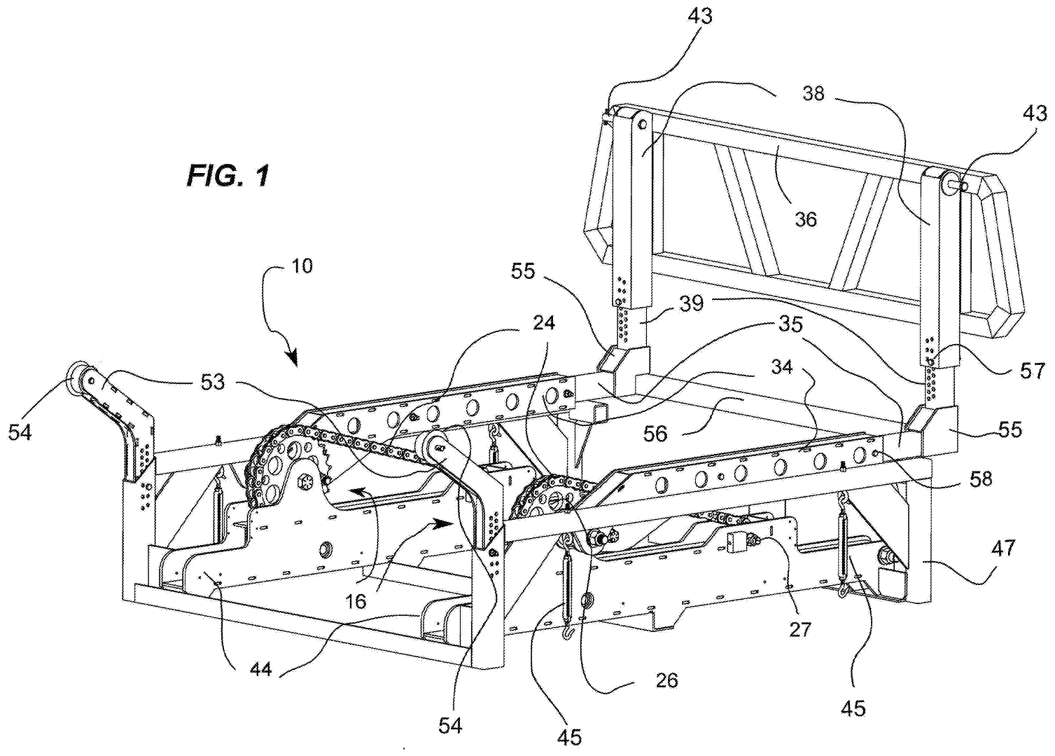

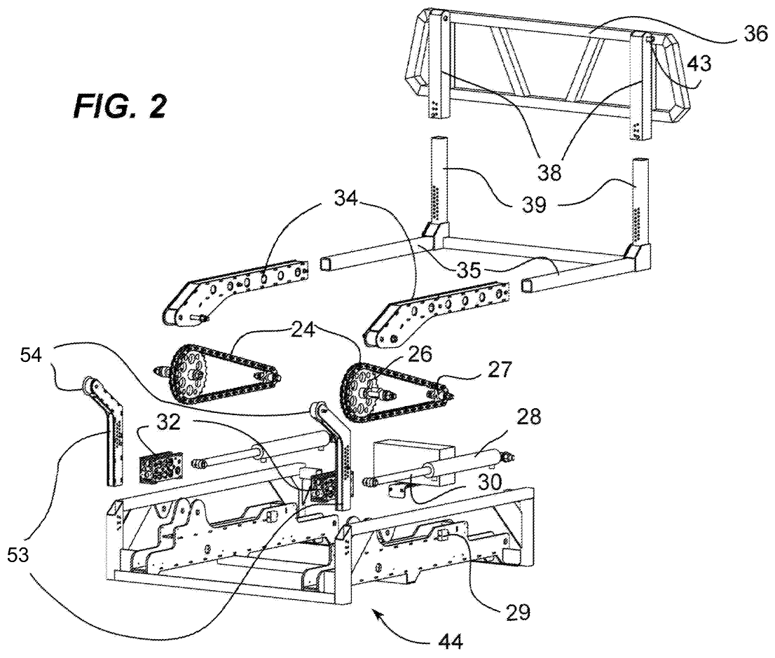

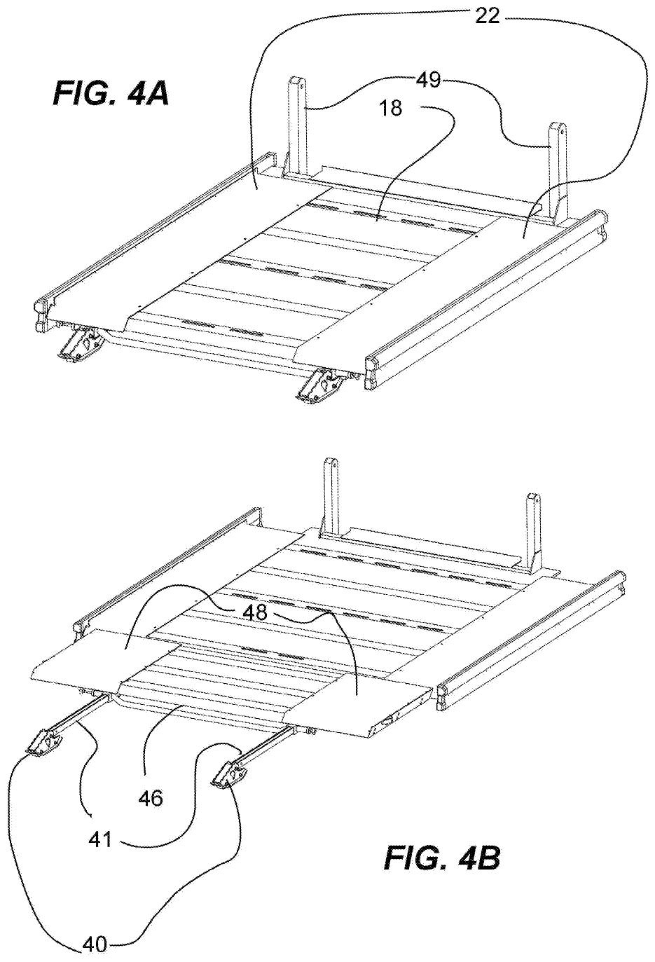

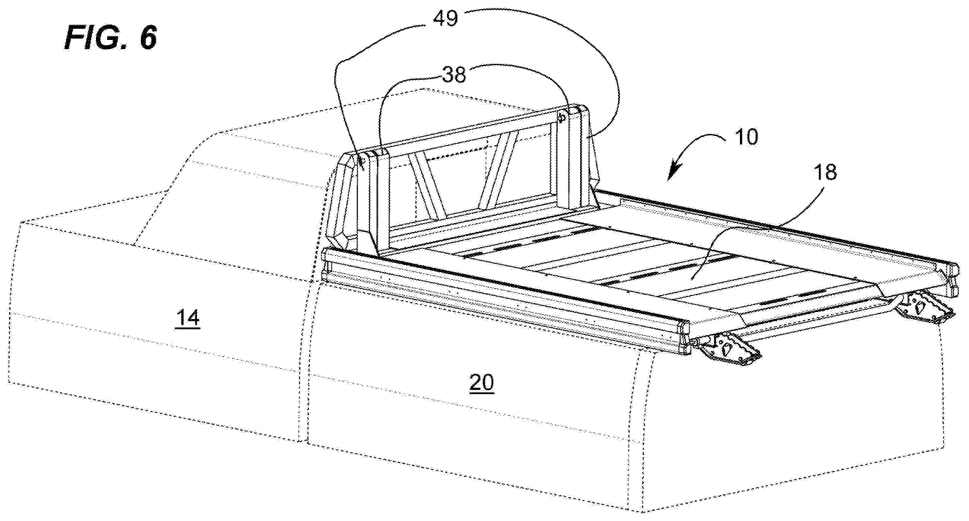

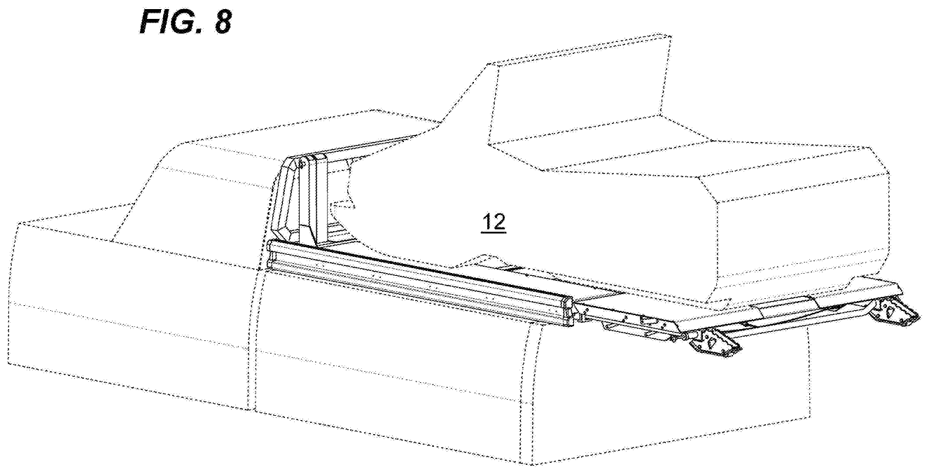

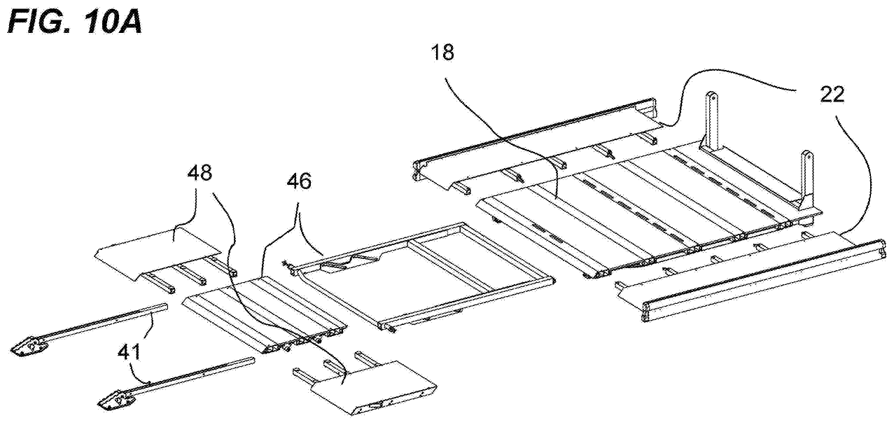

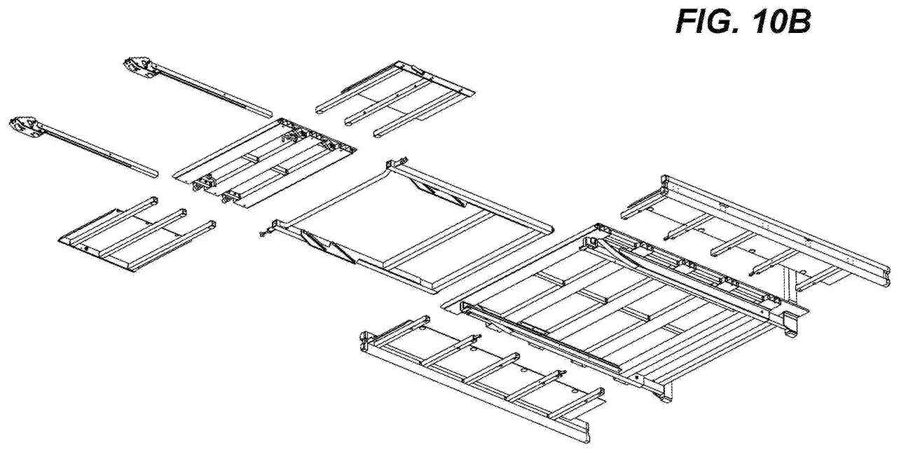

Referring now to FIGS. 1-10, a hydraulic deck 10 and various components of the hydraulic deck are illustrated. The hydraulic deck is configured to be positioned in a bed 20 of a pickup truck 14. The hydraulic lift comprises a mechanically operated lifting system 16 having a pair of chain loops 24 engaging a first and second pair of sprockets 26 and 27 respectively, wherein each of the first and second sprockets of the pair of sprockets are located at opposite ends of the pair of chain loops. The lifting system further comprises a pair of piston members 28 each having a piston rod 30 connected to the pair of chain loops via a pair of connection brackets 32. The operation and further components of the lifting system will be described in detail below.

The hydraulic deck further comprises a pair of horizontal frame members 35 and a pair of vertical frame members 39 joined via connection brackets 55 at respective proximal ends. In one embodiment, a perpendicular support frame member 56 is attached to the connection brackets, the length of the perpendicular support frame determining the width between the horizontal frame members. A pair of pivot arm members 34 is connected to the pair of horizontal frame members and a pair of extension members 38 is connected to the pair of vertical frame members. In one embodiment, the pivot arm members and extension members telescope on the horizontal and vertical frame members respectively, wherein the length of each combination is adjustable via bolts 57/58 or any other mechanical fastener as well known in the art. The adjustable combination is a particular advantage of the present invention, as the size of the frame is adjustable and is configured to allow the hydraulic deck to fit various pickup truck bed sizes. In one embodiment, a head mount 36 is fixedly attached to the pair of extension members. In one embodiment, the vertical frame members and the respective extension members are configured to fit in the front of pickup truck bed.

In one embodiment, pin members 43 are positioned at a top portion of each of the pair of extension members. In one embodiment, pillars 49 are rotationally connected to the pin members, wherein the pillars extend perpendicularly from a platform member 18. The platform member is configured to support a vehicle 12. In alternative embodiments, more than one vehicle, such as two vehicles side by side can be configured to fit when extension support members 22 are provided. The vehicle may be any sized vehicle that fits the platform member, but the hydraulic deck is specifically configured for an all-terrain vehicle (ATV), an off-highway vehicle (OHV), a utility vehicle (UTV), a motorcycle, or a sled vehicle, such as a snowmobile.

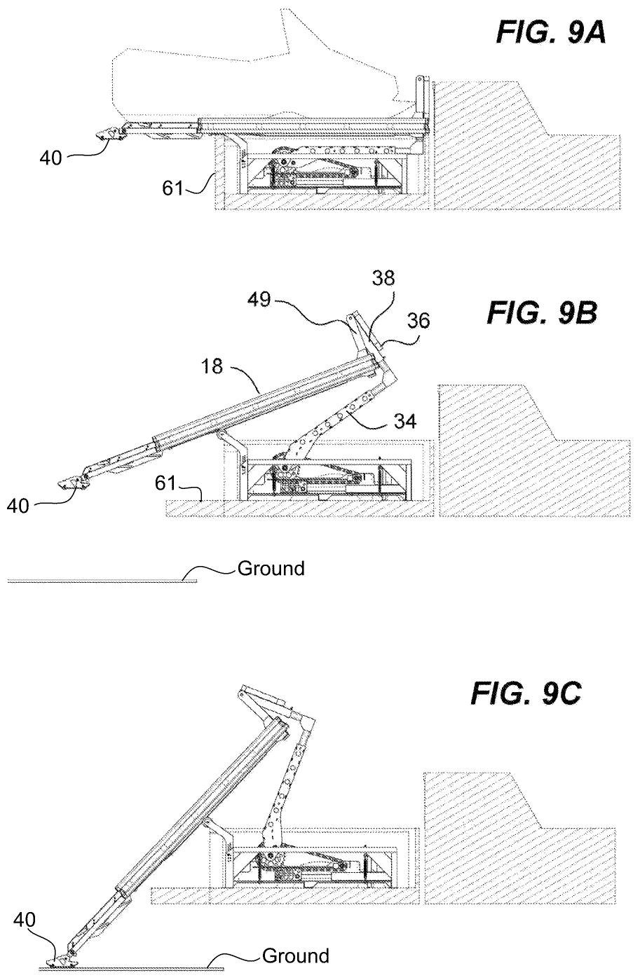

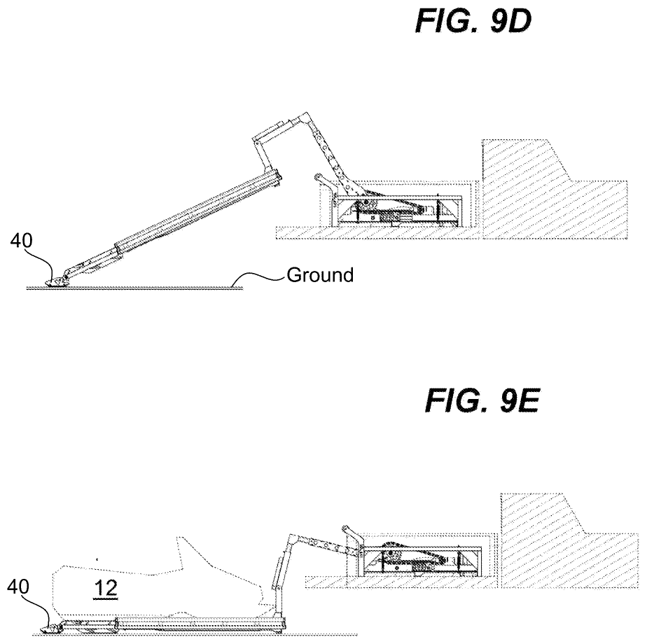

During operation, when the piston rods retract, the pair of chain loops and the first sprockets rotate. As the first sprockets rotate, the pair of pivot arm members connected the first sprockets rotate which lifts and slides the platform member out of the bed of the pickup truck and progressively down to the ground as seen in FIGS. 9A-E. The pillar members rotate relative to the extension members as the platform member is lowered to the ground. This is a particular advantage of the present invention, as it allows a vehicle 12 to be placed and/or driven on the platform when the platform is on ground level, so there is no need for a ramp.

In one embodiment, sprocket adjustment members 29 are provided, wherein the sprocket adjustment member adjusts the distance between the first and second sprockets to regulate the tension of the chain loop, thus the energy transfer from the energy required to lower and raise the platform can be adjusted and controlled if needed.

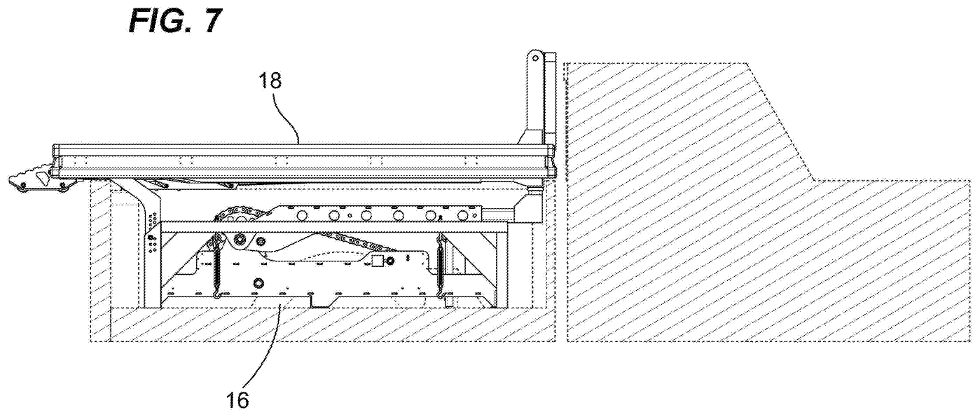

In one embodiment, the mechanically operated lifting system is located in the bed of the pickup truck under the platform member, best seen in FIG. 7. In one embodiment, the lifting system further comprises a structural body 47 configured and sized to fit inside the bed of the pickup truck. In one embodiment, a plurality of turnbuckles 45 are used to attach the structural body to the bed, such as via hook receiving members (not illustrated) found in bed of the pickup truck as well known in the art. The components of the lifting system, including but not limited to the pair of chain loops, the first and second sprocket, the pair of piston members, and connection brackets are all designed to fit inside a pair of weldments 44 forming part of the structural body, best seen in FIG. 1. In one embodiment, the structural body comprises has a pair of extension elements 53, each having a caster wheel 54 at each respective distal end of the pair of extension elements. In one embodiment, the pair of extension elements is constructed with a hockey stick shape. The extension elements help support and guide the platform member during operation.

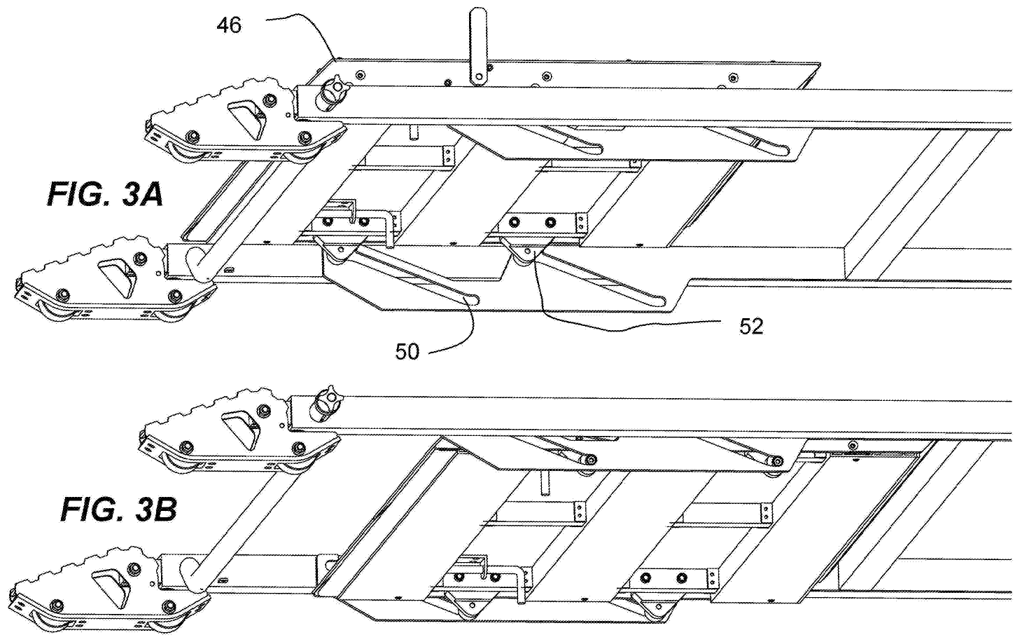

Best seen in FIGS. 3A-B, 4B, and 10A-B, in one embodiment, a sub platform 46 is provided underneath the platform member. The sub platform includes a pair of support ledges 48 configured to provide support when the vehicle is of the sled variety, such as the skis of a snowmobile. Referring now to FIGS. 3A and 3B, at least one diagonal channel 50 is configured to accept at least one roller element 52 to facilitate the sub platform being extended and retracted from underneath the platform member. It is a particular advantage of the present invention that the at least one diagonal channel allows the sub platform to be positioned underneath the platform member when recessed (FIG. 3B/4A).

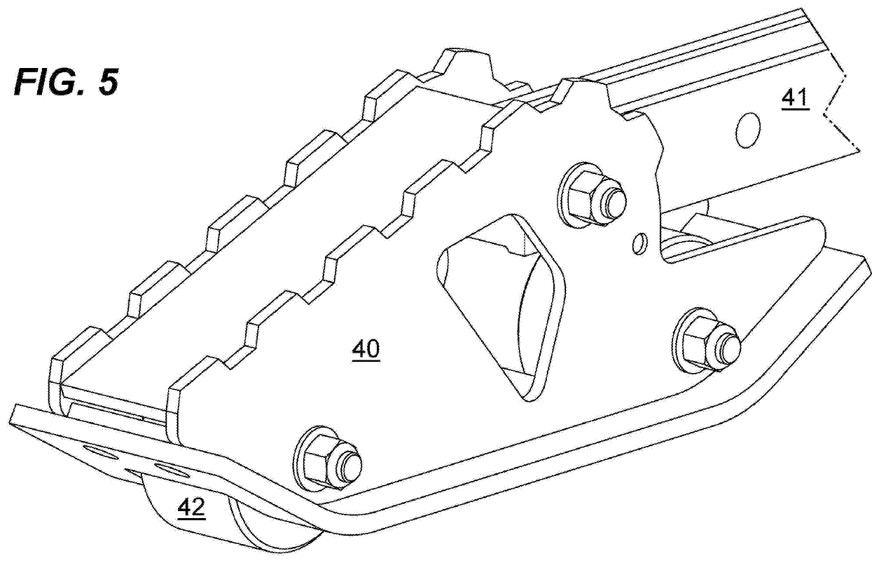

In one embodiment, a pair of skates 40 extends from protracting members 41, wherein the skates make first contact with the ground when the platform member is lowered. Best seen in FIG. 5, each of the pair of skates include a wheel 42 facilitating the operation of the platform member after contact and guiding the platform member on the ground as seen in FIGS. 9C-E.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1-16. (canceled)

17. A skate for use with a vehicle platform for a pickup truck and for guiding on a ground surface said vehicle platform, the skate comprising:
a front wheel-assembly comprising at least one front wheel and a front wheel-axle;
a rear wheel-assembly comprising at least one rear wheel and a rear wheel-axle; and
a body comprising a bottom side having a mostly flat lowest and central portion, and a pivot couplable to said vehicle platform;
wherein said front wheel-axle is coupled to said body near a front of said mostly flat lowest and central portion so that said front wheel protrudes from said bottom side of said body, parallel to said mostly flat lowest and central portion, and extending through a width of said body;
wherein said rear wheel-axle is coupled to said body near a rear of said mostly flat lowest and central portion so that said rear wheel protrudes from said bottom side of said body, parallel to said front wheel-axle, and extending through said width of said body;
wherein said skate, when coupled to said vehicle platform, rotates in relation to said vehicle platform around said pivot to ensure that said mostly flat lowest and central portion remains about parallel to ground surface so that at least one of said front wheel or said rear wheel makes a first contact with said ground when said vehicle platform is being lowered.

18. The skate defined in claim 17, wherein said body comprises a left-wall on a left side of said body, a right-wall on a right side of said body, and wherein said bottom side extends at least between said left-wall and said right-wall.

19. The skate defined in claim 18, wherein said front wheel-axle is coupled at a first end to said left-wall and coupled at a second opposed end of said front wheel-axle to said right-wall, and wherein said rear wheel-axle is coupled at a first end to said left-wall and coupled at a second opposed end of said rear wheel-axle to said right-wall.

20. The skate defined in claim 17, wherein said pivot is couplable to a most rear end of said vehicle platform that would make a first ground contact if no skate were attached thereto, thereby ensuring that said skate makes a first contact with said ground surface when said vehicle platform is being deployed and makes said first contact to said ground surface.

21. The skate defined in claim 20, wherein said most rear end is a protracting member of said vehicle platform.

22. The skate defined in claim 17, wherein said front wheel-assembly comprises only one of said at least one front wheel.

23. The skate defined in claim 17, wherein said rear wheel-assembly comprises only one of said at least one rear wheel.

24. The skate defined in claim 17, wherein said front wheel-assembly further comprises at least one front wheel-bearing.

25. The skate defined in claim 24, wherein said front wheel is coupled to said front wheel-axle through one of said at least one front wheel-bearing.

26. The skate defined in claim 17, wherein said rear wheel-assembly further comprises at least one rear wheel-bearing.

27. The skate defined in claim 24, wherein said rear wheel is coupled to said rear wheel-axle through one of said at least one rear wheel-bearing.

28. The skate defined in claim 17, wherein said bottom side is a ski-shaped surface.

29. The skate defined in claim 28, wherein a front tip and a rear tip of said ski-shaped surface curve upwardly from said mostly flat lowest and central portion.

30. The skate defined in claim 28, wherein front wheel-axle is coupled to said body near an upward curve of said front tip, and wherein rear wheel-axle is coupled to said body near an upward curve of said rear tip.

31. The skate defined in claim 17, wherein said ski-shaped surface extends through a length of said body.

32. The skate defined in claim 17, wherein said pivot comprises a pivot axle parallel to said front wheel-axle and couplable to said vehicle platform.

33. The skate defined in claim 17, wherein said rear wheel and said front wheel protrude downwardly by a same distance from said mostly flat lowest and central portion.

34. The skate defined in claim 17, wherein said ground surface is perpendicular to a direction of gravitational acceleration.
